(19) United States
(12) Patent Application Publication
(10) Pub. No.: US 2015/0221253 A1
(43) Pub. Date: Aug. 6, 2015

(54) DISPLAY DEVICE AND ELECTRONIC APPARATUS

(71) Applicant: Sony Corporation, Tokyo (JP)

(72) Inventors: Tetsuro Yamamoto, Kanagawa (JP); Katsuhide Uchino, Kanagawa (JP)

(73) Assignee: SONY CORPORATION, Tokyo (JP)

(21) Appl. No.: 14/421,350

(22) PCT Filed: Aug. 23, 2013
(86) PCT No.: PCT/JP2013/005000

§ 371 Date: Feb. 12, 2015

(30) Foreign Application Priority Data
Aug. 31, 2012 (JP) 2012-191639

(51) Int. Cl. G09G 3/32

(52) U.S. Cl. CPC G09G 3/3233; G09G 2300/0819; G09G 2300/0852; G09G 2300/0866; G09G 2320/043; G09G 2320/02

(57) ABSTRACT

To provide a display device that can reduce image quality degradation caused by blunting of the waveform of the control pulse for controlling a sampling transistor, and an electronic apparatus including the display device. The display device according to an embodiment of this disclosure has a pixel circuit arranged therein, the pixel circuit including an electrooptic element, a drive transistor for driving the electrooptic element, and a first capacitative element connected between the gate electrode of the drive transistor and one of the source/drain electrodes of the drive transistor. The pixel circuit writes a video signal, and includes a timing circuit capable of adjusting the time for writing the video signal.

### TECHNICAL FIELD

This disclosure relates to display devices and electronic apparatuses, and more particularly, to a flat-panel display device and an electronic apparatus including the display device.

### BACKGROUND ART

As one type of flat-panel display devices, there are display devices that use so-called current-drive electrooptic elements as the light emitting units (light emitting elements) of the pixels. A current-drive electrooptic element has emission luminance that varies with the value of current flowing in the device. As such current-drive electrooptic elements, organic EL elements are known. Organic EL elements use the electroluminescence (EL) of an organic material, and take advantage of light emission that occurs when an electric field is applied to an organic thin film.

A flat-panel display device that may typically be an organic EL display device has a structure in which pixels (pixel circuits) including at least an electrooptic element, a sampling transistor, a capacitative element, and a drive transistor are two-dimensionally arranged in a matrix fashion (see Patent Document 1, for example).

The sampling transistor is driven by a control pulse (a scanning signal) supplied through a control line (a scanning line) provided for each pixel row. The sampling transistor samples the signal voltage of a video signal supplied through a signal line, and writes the signal voltage into the pixel. The capacitative element holds the signal voltage written by the sampling transistor. The drive transistor drives the electrooptic element in accordance with the signal voltage held in the capacitative element.

### CITATION LIST

### Patent Literature

[PTL 1]
JP 2007-310311A

### SUMMARY

### Technical Problem

In the above described display device, higher definition and higher luminance lead to a decrease in the opening area of each pixel, and to a decrease in the overall capacitance. As a result, the time for writing the signal voltage of a video signal tends to become shorter. Meanwhile, the waveform of the control pulse (a scanning pulse/a scanning signal) controlling (driving) the sampling transistor becomes blunt due to the influence of a propagation delay caused by the interconnect resistance and the interconnect capacitance of the control line (the scanning line) transmitting the control pulse.

The blunt waveform of the control pulse affects the time for the sampling transistor to write the signal voltage.

That is, where the waveform of the control pulse becomes blunt, the time for writing the signal voltage becomes shorter than that in a case where the waveform of the control pulse is sharp, and the time subtraction is too large to ignore. Specifically, as the influence of blunting of the waveform of the control pulse on the writing time becomes larger, image defects such as shading are caused.

Therefore, it is desirable to provide a display device that can reduce image quality degradation caused by blunting of the waveform of the control pulse for controlling a sampling transistor, and an electronic apparatus including the display device.

### Solution to Problem

According to an embodiment of this disclosure a display device has a pixel circuit arranged therein, and the pixel circuit includes an electrooptic element, a drive transistor for driving the electrooptic element, and a first capacitative element connected between the gate electrode of the drive transistor and one of the source/drain electrodes of the drive transistor. In this display device, the pixel circuit writes a video signal, and includes a timing circuit that is capable of adjusting the time for writing the video signal. The display device according to an embodiment of this disclosure can be used as a display unit in various kinds of electronic apparatuses.

According to another embodiment, a pixel circuit is described and comprises an electro-optical element; a first capacitive element and a second capacitive element, the first capacitive element and the second capacitive element being connected at a node; a first sampling transistor, the second capacitive element being connected to a current terminal of the first sampling transistor, the first sampling transistor being configured to sample an input signal from a signal line connected into at least said second capacitive element; a second sampling transistor; and a drive transistor having a gate terminal, a first current terminal and a second current terminal, the gate terminal being connected to the first capacitive element, the first current terminal being connected to a power supply line, and the second current terminal being connected to the electro-optical element, the drive transistor being configured to apply current to said electro-optical element depending on the input signal held by at least said second capacitive element. During a first period the second sampling transistor is configured to apply a reference potential to the gate terminal of the drive transistor, and during a correction period occurring after of the first period, the second sampling transistor is configured to disconnect the reference potential from the gate terminal of the drive transistor.

A display device and corresponding electronic apparatus may include the pixel circuit of this embodiment.

In the display device having the above described structure or an electronic apparatus including the display device, the timing circuit is provided in the pixel circuit, so that the writing time for writing a video signal can be adjusted by virtue of a function of the timing circuit. With this structure, even if the time for writing a video signal is shortened due to blunting of the waveform of the control pulse for the sampling transistor sampling the video signal, the writing time can be adjusted to the original time length that is maintained as long as the waveform of the control pulse is sharp.

### Advantageous Effects of Invention

According to an embodiment of this disclosure, even if the time for writing a video signal is shortened due to blunting of the waveform of the control pulse for the sampling transistor sampling the video signal, the writing time can be adjusted. Thus, image quality degradation caused by the blunting of the waveform of the control pulse can be reduced.

### [BRIEF DESCRIPTION OF DRAWINGS]

FIG. 1 is a system configuration diagram schematically showing a basic structure of an active-matrix display device according to an embodiment of this disclosure.

FIG. 2 is a circuit diagram showing a specific example circuit configuration of a pixel (a pixel circuit).

FIG. 3 is a timing waveform chart for explaining basic circuit operations of an active-matrix organic EL display device according to the embodiment.

FIG. 4 is an operation explanatory diagram (1) of the basic circuit operations of the active-matrix organic EL display device according to the embodiment.

FIG. 5 is an operation explanatory diagram (2) of the basic circuit operations of the active-matrix organic EL display device according to the embodiment.

FIG. 6 is an operation explanatory diagram (3) of the basic circuit operations of the active-matrix organic EL display device according to the embodiment.

FIG. 7 is an operation explanatory diagram (4) of the basic circuit operations of the active-matrix organic EL display device according to the embodiment.

FIG. 8 is an operation explanatory diagram (5) of the basic circuit operations of the active-matrix organic EL display device according to the embodiment.

FIG. 9 is an operation explanatory diagram (6) of the basic circuit operations of the active-matrix organic EL display device according to the embodiment.

FIG. 10 is a diagram showing a variation of the source potential Vₛ of the drive transistor at the time of charging the first capacitative element and the equivalent capacitance of the organic EL element.

FIG. 11 is a diagram showing variations of the source potential Vₛ of the drive transistor observed when the mobility μ of the drive transistor is high and when the mobility μ is low.

FIG. 12 is a timing waveform chart showing a timing relationship according to a modification of the embodiment.

### DESCRIPTION OF EMBODIMENTS

The following is a detailed description of a mode for carrying out the technique according to an embodiment of this disclosure (hereinafter referred to as the “embodiment”), with reference to the accompanying drawings. The technique according to an embodiment of this disclosure is not limited to the embodiment. In the following description, like components or components having like functions are denoted by like reference numerals, and explanation of them will not be made more than once. Explanation will be made in the following order.

1. General description of a display device and an electronic apparatus according to an embodiment of this disclosure

2. Active-matrix display device according to the embodiment

2-1. System configuration

2-2. Pixel circuit

2-3. Basic circuit operations

2-4. Functions and effects of the embodiment

3. Modifications

4. Electronic apparatus

5. Structures according to an embodiment of this disclosure

<1. General Description of a Display Device and an Electronic Apparatus According to an Embodiment of this Disclosure>

A display device according to an embodiment of this disclosure is a flat-panel display device formed by arranging pixel circuits each including an electrooptic element, a drive transistor driving the electrooptic element, and a first capacitative element connected between the gate electrode of the drive transistor and one of the source/drain electrodes of the drive transistor.

Examples of flat-panel display devices include organic EL display devices, liquid crystal display devices, and plasma display devices. Of those display devices, organic EL display devices use organic EL elements as the light emitting elements (electrooptic elements) of the pixels. The organic EL elements use the electroluminescence of an organic material, and take advantage of light emission that occurs when an electric field is applied to an organic thin film.

An organic EL display device using organic EL elements as the light emitting units of the pixels has the following features. As the organic EL elements can be driven by an applied voltage of 10 V or lower, the organic EL display device consumes a small amount of power. As the organic EL elements are light emitting elements, the organic EL display device has a higher level of image visibility than a liquid crystal display device that is also a flat-panel display device. Requiring no lighting units such as backlights, the organic EL display device can be easily made lighter and thinner. Further, the response speed of the organic EL elements is several μsec, which is very high. Accordingly, no residual images are formed when the organic EL display device is displaying a moving image.

Organic EL elements are current-drive electrooptic elements. Examples of current-drive electrooptic elements include not only organic EL elements but also inorganic EL elements, LED elements, and semiconductor laser elements.

A flat-panel display device such as an organic EL display device can be used as a display unit (a display device) in various kinds of electronic apparatuses. Examples of various kinds of electronic apparatuses include digital cameras, video cameras, game machines, notebook-size personal computers, portable information terminals such as e-book readers, and portable communication devices such as PDAs (Personal Digital Assistants) and portable telephone devices.

In a display device including a pixel circuit that has the above described structure, the pixel circuit writes a video signal, and includes a timing circuit that is capable of adjusting the time for writing the video signal. As the pixel circuit includes the timing circuit, the time for writing a video signal can be adjusted by virtue of a function of the timing circuit. With this structure, even if the time for writing a video signal is shortened due to blunting of the waveform of the control pulse for the sampling transistor sampling the video signal, the writing time can be adjusted to the original time length that is maintained as long as the waveform of the control pulse is sharp.

In a display device and an electronic apparatus according to an embodiment of this disclosure including the above described preferred structure, the timing circuit can be designed to adjust the time for writing a video signal through capacitance sharing with the first capacitative element. Specifically, the timing circuit may be formed with a first sampling transistor having one of its source/drain electrodes connected to a signal line, a second capacitative element connected between the other one of the source/drain electrodes of the first sampling transistor and the gate electrode of the drive transistor, and a second sampling transistor connected between the signal line and the gate electrode of the drive transistor.

The timing circuit having the above described structure may write a video signal while applying current to the drive transistor by putting the first sampling transistor into a conductive state and putting the second sampling transistor into a non-conductive state. When writing the video signal, the timing circuit may interpose the second capacitative element between the signal line and the gate electrode of the drive transistor, and adjust the time for writing the video signal through capacitance sharing with the first capacitative element and the second capacitative element.

Also, in the display device and the electronic apparatus according to an embodiment of this disclosure including the above described preferred structure, after a video signal is supplied to the signal line, the pixel circuit may start writing the video signal at a time when the first sampling transistor is put into the conductive state.

Also, in the display device and the electronic apparatus according to an embodiment of this disclosure including the above described preferred structure, the pixel circuit may write a video signal and correct the mobility of the drive transistor while applying current to the drive transistor. In that case, the pixel circuit may correct the mobility of the drive transistor by applying a negative feedback to the potential difference between the gate and the source of the drive transistor by a correction amount that depends on the current flowing in the drive transistor.

<2. Active-Matrix Display Device According to the Embodiment>

(2-1. System Configuration)

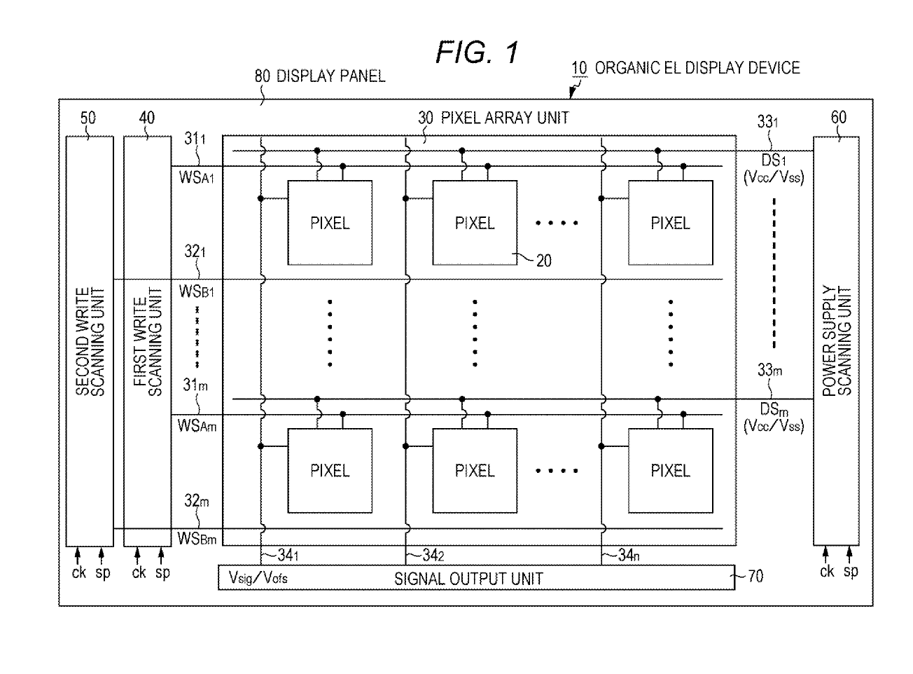

FIG. 1 is a system configuration diagram schematically showing a basic structure of an active-matrix display device according to an embodiment of this disclosure.

An active-matrix display device is a display device that controls current flowing in an electrooptic element with an active element provided in the same pixel as the electrooptic element, such as an insulated-gate field effect transistor. The insulated-gate field effect transistor may typically be a TFT (Thin Film Transistor).

The example described below is an active-matrix organic EL display device in which a current-drive electrooptic element having emission luminance that varies with the value of the current flowing in the device, such as an organic EL element, is used as a light emitting element of each pixel (pixel circuit).

As shown in FIG. 1, an organic EL display device 10 according to this embodiment includes: a pixel array unit 30 formed by two-dimensionally arranging pixels (pixel circuits) 20 each including a light emitting element in a matrix fashion; and a drive circuit unit (drive unit) placed around the pixel array unit 30. The drive circuit unit is formed with a first write scanning unit 40, a second write scanning unit 50, a power supply scanning unit 60, and a signal output unit 70, and are mounted on a substrate serving as a display panel 80.

In a case where the organic EL display device 10 is compatible with color display, one pixel serving as a unit to form a color image (a unit pixel) is formed with sub pixels, and the respective sub pixels are equivalent to the pixels 20 shown in FIG. 1. More specifically, in the display device compatible with color display, one pixel is formed with the three sub pixels: a sub pixel that emits red (R) light, a sub pixel that emits green (G) light, and a sub pixel that emits blue (B) light, for example.

However, each one pixel is not limited to the combination of the sub pixels of the three primary colors of RGB, and may be formed by adding one or more color sub pixels to the sub pixels of the three primary colors. More specifically, each one pixel may be formed by adding a sub pixel that emits white (W) light to increase luminance, or may be formed by adding at least one sub pixel that emits complementary-color light to expand the color reproduction range, for example.

In the pixel array unit 30, first scanning lines 31₁ through 31ₘ, second scanning lines 32₁ through 32ₘ, and power supply lines 33₁ through 33ₘ are placed in respective pixel rows in the row direction (the array direction of the pixels arranged in the pixel rows) in the array of m rows and n columns of pixels 20. Further, signal lines 34₁ through 34ₙ are placed in the respective pixel columns in the column direction (the array direction of the pixels arranged in the pixel columns) in the array of the m rows and n columns of the pixels 20.

The first scanning lines 31₁ through 31ₘ are connected to the respective corresponding output terminals of the first write scanning unit 40. The second scanning lines 32₁ through 32ₘ are connected to the respective corresponding output terminals of the second write scanning unit 50. The power supply lines 33₁ through 33ₘ are connected to the respective corresponding output terminals of the power supply scanning unit 60. The signal lines 34₁ through 34ₙ are connected to the respective output terminals of the corresponding columns of the signal output unit 70.

The first and second write scanning units 40 and 50 are formed with shift register circuits or the like that sequentially shift (transfer) a start pulse sp in synchronization with a clock pulse ck. To write the signal voltage of a video signal into each pixel 20 of the pixel array unit 30, those write scanning units 40 and 50 sequentially supply first and second write scanning signals WS_{A} (WS_{A1} through WS_{Am}) and WS_{B} (WS_{B1} through WS_{Bm}) to the first and second scanning lines 31 (31₁ through 31ₘ) and 32 (32₁ through 32ₘ). With that, the respective pixels 20 of the pixel array unit 30 are sequentially scanned row by row (line sequential scanning).

The power supply scanning unit 60 is formed with a shift register circuit or the like that sequentially shifts the start pulse sp in synchronization with the clock pulse ck. In synchronization with the line sequential scanning by the write scanning circuits 40 and 50, this power supply scanning unit 60 supplies a power source potential DS (DS₁ through DSₘ) that can switch between a first power source potential V_{cc} and a second power source potential Vₛₛ lower than the first power source potential V_{cc} to the power supply lines 33 (33₁ through 33ₘ). As will be described later, light emission and no-light emission (quenching) from the pixels 20 is controlled by switching the power source potential DS between V_{cc} and Vₛₛ.

The signal output unit 70 selectively outputs the signal voltage (hereinafter also referred to simply as the “signal voltage” in some cases) V_{sig} of a video signal according to luminance information supplied from a signal supply source (not shown) and a reference potential V_{ofs}. Here, the reference potential V_{ofs} is the potential serving as the reference for the signal voltage V_{sig} of a video signal (such as the potential equivalent to the black level of a video signal), and is used in the later described threshold value correcting process.

The signal voltage V_{sig} and the reference potential V_{ofs} output from the signal output unit 70 are written into the respective pixels 20 of the pixel array unit 30 via the signal lines 34 (34₁ through 34ₙ) for each of pixel rows selected by the scanning by the first and second write scanning circuits 40 and 50. That is, the signal output unit 70 uses a line sequential write drive technique to write the signal voltage V_{sig} of a video signal row by row (line by line).

(2-2. Pixel Circuit)

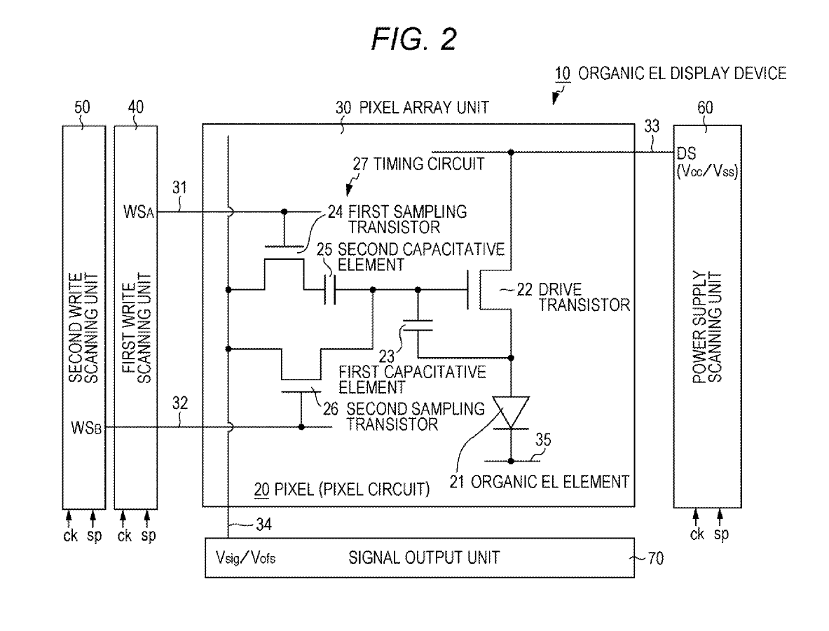

FIG. 2 is a circuit diagram showing a specific example of the circuit configuration of a pixel (a pixel circuit) 20. The light emitting unit of the pixel 20 is formed with an organic EL element 21 that is a current-drive electrooptic element having emission luminance that varies with the value of the current flowing in the device.

As shown in FIG. 2, the pixel 20 includes the organic EL element 21 and a drive circuit that drives the organic EL element 21 by applying current to the organic EL element 21. The organic EL element 21 has a cathode electrode connected to a common power supply line 35 connected to all the pixels 20.

The drive circuit that drives the organic EL element 21 includes a drive transistor 22, a first capacitative element 23, a first sampling transistor 24, a second capacitative element 25, and a second sampling transistor 26. N-channel TFTs can be used as the drive transistor 22 and the first and second sampling transistors 24 and 26. However, the above described combination of the drive transistor 22 and the conductivity type of the drive transistor 22 and the sampling transistors 24 and 26 is merely an example, and the present disclosure is not limited to the above combination.

The drive transistor 22 has one of the electrodes (the source/drain electrodes) connected to the anode electrode of the organic EL element 21, and has the other one of the electrodes (the source/drain electrodes) connected to the power supply line 33 (33₁ through 33ₘ). The first capacitative element 23 has one of the electrodes connected to the gate electrode of the drive transistor 22, and has the other one of the electrodes connected to the other electrode of the drive transistor 22 and the anode electrode of the organic EL element 21.

The first sampling transistor 24 has one of the electrodes connected to the signal line 34 (34₁ through 34ₙ). The gate electrode of the first sampling transistor 24 is connected to the first scanning line 31 (31₁ through 31ₘ). The second capacitative element 25 has one of the electrodes connected to the other electrode of the first sampling transistor 24, and has the other one of the electrodes connected to the gate electrode of the drive transistor 22.

The second sampling transistor 26 has one of the electrodes connected to the signal line 34 (34₁ through 34ₙ), and has the other one of the electrodes connected to the gate electrode of the drive transistor 22. The gate electrode of the second sampling transistor 26 is connected to the second scanning line 32 (32₁ through 32ₘ).

In each of the drive transistor 22 and the first and second sampling transistors 24 and 26, “one of the electrodes” means a metal interconnect electrically connected to one of the source/drain regions, and “the other one of the electrodes” means a metal interconnect electrically connected to the other one of the source/drain regions. Depending on the potential relationship between one of the electrodes and the other one of the electrodes, the one of the electrodes may be either the source electrode or the drain electrode, and the other one of the electrodes may be either the drain electrode or the source electrode.

The drive circuit of the organic EL element 21 does not necessarily have a circuit configuration including the two capacitative elements (23, 25). For example, one of the electrodes may be connected to the anode electrode of the organic EL element 21, and the other one of the electrodes may be connected to a fixed potential. In such a circuit configuration, a capacitative element to compensate for insufficient capacitance of the organic EL element 21 is provided where necessary.

In the pixel (pixel circuit) 20 having the above described structure, the first sampling transistor 24, the second capacitative element 25, and the second sampling transistor 26 writes the signal voltage V_{sig} of a video signal into the pixel, and constitute a timing circuit 27 that is capable of adjusting the time for writing the signal voltage V_{sig}. This timing circuit 27 can adjust the time for writing the signal voltage V_{sig} through capacitance sharing with the first capacitative element 23.

Specifically, the timing circuit 27 puts the first sampling transistor 24 into a conductive state, and puts the second sampling transistor 26 into a non-conductive state, to write the signal voltage V_{sig} of a video signal while applying current to the drive transistor 22. In writing the signal voltage V_{sig}, the timing circuit 27 interposes the second capacitative element 25 between the signal line 34 and the gate electrode of the drive transistor 22, to adjust the time for writing the signal voltage V_{sig} through capacitance sharing with the first capacitative element 23 and the second capacitative element 25.

The first and second sampling transistors 24 and 26 perform sampling on the reference potential V_{ofs} supplied from the signal output unit 70 through the signal line 34 where appropriate, and writes the reference potential V_{ofs} into the pixel. The signal voltage V_{sig} of a video signal and the reference potential V_{ofs} written in the pixel are applied to the gate electrode of the drive transistor 22, and are held in the first capacitative element 23.

When the power source potential DS of the power supply line 33 (33₁ through 33ₘ) is the first power source potential V_{cc}, the drive transistor 22 operates in a saturation region, with one of the electrodes being the drain electrode, the other one of the electrodes being the source electrode. With that, the drive transistor 22 receives a current supply from the power supply line 33, and drives light emission of the organic EL element 21 with the current. More specifically, the drive transistor 22 driving in a saturation region supplies a drive current having a current value varying with the voltage value of the signal voltage V_{sig} held in the first capacitative element 23, to the organic EL element 21, and drives the organic EL element 21 to light emission with the current.

When the power source potential DS switches from the first power source potential V_{cc} to the second power source potential Vₛₛ, the drive transistor 22 further operates as a switching transistor, with the one of the electrodes being the source electrode, the other one of the electrodes being the drain electrode. With that, the drive transistor 22 stops the drive current supply to the organic EL element 21, and puts the organic EL element 21 into a no-light emission state. That is, the drive transistor 22 also has the function of a transistor that controls light emission and no-light emission from the organic EL element 21.

By the switching operation of the drive transistor 22, a period during which the organic EL element 21 is in a no-light emission state (a no-light emitting period) is set, and the ratio (duty) between the light emitting period and the no-light emitting period of the organic EL element 21 can be controlled. Through this duty control, residual image blurring caused by light emission from the pixel 20 over a one-frame display period can be reduced. Thus, the quality of images, particularly, the quality of moving images, can be further improved.

Of the first and second power source potentials V_{cc} and Vₛₛ to be selectively supplied from the power supply scanning unit 60 through the power supply line 33, the first power source potential V_{cc} is the power source potential for supplying the drive current for driving the organic EL element 21 to light emission, to the drive transistor 22. The second power source potential Vₛₛ is the power source potential for applying an inverse bias to the organic EL element 21. When the second power source potential Vₛₛ is lower than the reference potential V_{ofs}, or is set at a potential that is lower than V_{ofs}−Vₜₕ, or more preferably, a potential that is sufficiently lower than V_{ofs}−Vₜₕ, where Vₜₕ represents the threshold voltage of the drive transistor 22.

(2-3. Basic Circuit Operations)

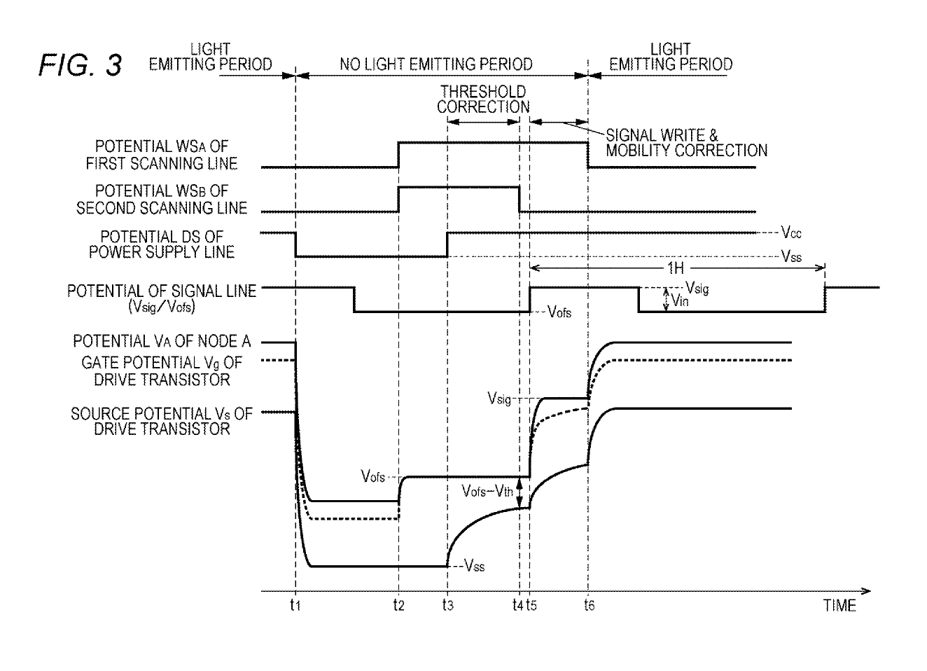

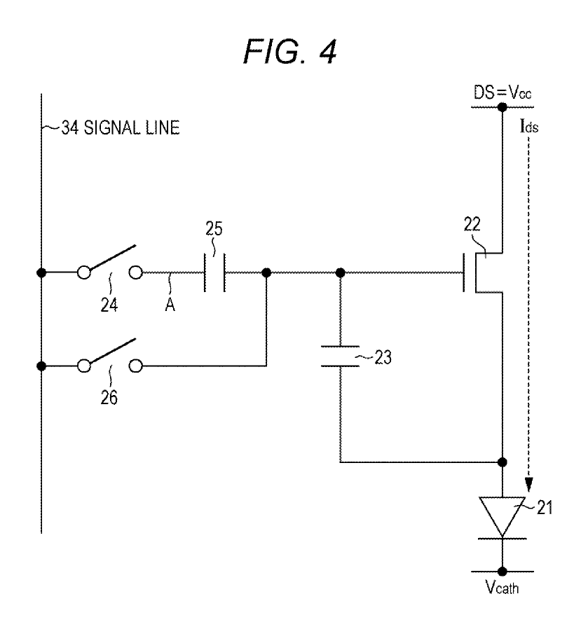

Next, basic circuit operations of the organic EL display device 10 according to this embodiment having the above described structure are described, with reference to the timing waveform chart shown in FIG. 3 and the operation explanatory diagrams shown in FIGS. 4 through 9. In the operation explanatory diagrams shown in FIGS. 4 through 9, the switches of the first and second sampling transistors 24 and 26 are indicated by symbols, for simplification of the drawings.

The timing waveform chart in FIG. 3 shows respective variations of the potential WS_{A} of the first scanning line 31, the potential WS_{B} of the second scanning line 32, the potential (power source potential) DS of the power supply line 33, the potential (V_{sig}/V_{ofs}) of the signal line 34, and the gate potential V_{g} and the source potential Vₛ of the drive transistor 22. Where the connection node between the first sampling transistor 24 and the second capacitative element 25 is a node A, a variation of the potential V_{A} of the node A is also shown.

(Light Emitting Period of a Previous Display Frame)

In the timing waveform chart in FIG. 3, the period before time t₁ is the light emitting period of the organic EL element 21 in the previous display frame. During the light emitting period of the previous display frame, the potential DS of the power supply line 33 is the first power source potential (hereinafter referred to as the “high potential) V_{cc}, and the first and second sampling transistors 24 and 26 are in a non-conductive (off) state, as shown in FIG. 4.

At this point, the drive transistor 22 is designed to operate in a saturation region. Accordingly, the drive current (drain-source current) I_{ds} that varies with the gate-source voltage V_{gs} of the drive transistor 22 is supplied from the power supply line 33 to the organic EL element 21 through the drive transistor 22. Thus, the organic EL element 21 emits light with luminance in accordance with the current value of the drive current I_{ds}.

The current I_{ds} flowing in the organic EL element 21 has the current value expressed by the following equation (1) in accordance with the gate-source voltage V_{gs} of the drive transistor 22.

I_{ds}=(1/2)×μ(W/L)Cₒₓ(V_{gs}−V_{tb})² (1)

Here, W represents the channel width of the drive transistor 22, L represents the channel length, Cₒₓ represents the gate capacitance per unit area, and Vₜₕ represents the threshold voltage of the drive transistor 22.

At time t₁, the operation enters a new display frame (the current display frame) in the line sequential scanning. The potential (power source potential) DS of the power supply line 33 then switches from the high potential V_{cc} to the second power source potential (hereinafter referred to as the “low potential”) Vₛₛ, which is sufficiently lower than V_{ofs}−Vₜₕ, with respect to the reference potential V_{ofs} of the signal line 34.

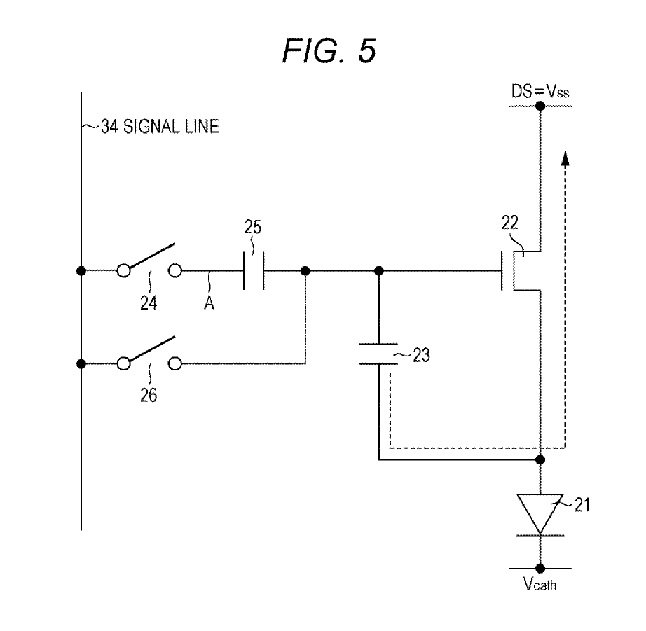

At this point, the drive transistor 22 operates in a linear region. Here, the threshold voltage of the organic EL element 21 is represented by Vₜₕₑ₁, and the potential (cathode potential) of the common power supply line 35 is represented by V_{cath}. Where the low potential Vₛₛ is expressed as Vₛₛ<Vₜₕₑ₁+V_{cath}, the source potential Vₛ of the drive transistor 22 becomes substantially equal to the low potential Vₛₛ, and therefore, the organic EL element 21 is put into a quenched state by an inverse bias. At this point, the current flows through the passage from the first capacitative element 23 to the source electrode of the drive transistor 22 to the drain electrode to the power supply line 33, as indicated by the dashed arrow in FIG. 5.

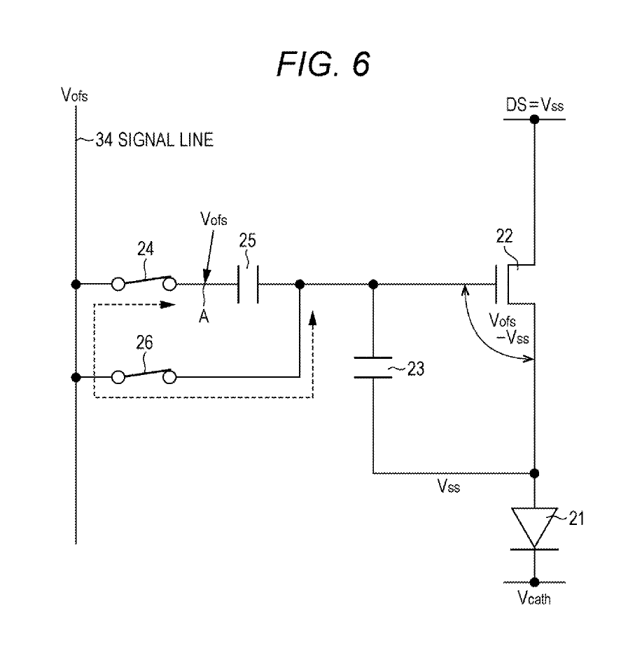

At time t₂, the potentials WS_{A} and WS_{B} of the first and second scanning lines 31 and 32 transit from the low-potential side to the high-potential side. With that, the first and second sampling transistors 24 and 26 enter a conductive (on) state, as shown in FIG. 6. Since the reference potential V_{ofs} is supplied from the signal output unit 70 to the signal line 34 at this point, the gate potential V_{g} of the drive transistor 22 and the potential V_{A} of the node A become equal to the reference potential V_{ofs}.

The gate-source voltage V_{gs} of the drive transistor 22 then becomes equal to V_{ofs}−Vₛₛ. Unless the gate-source voltage V_{gs}, or V_{ofs}−Vₛₛ, is higher than the threshold voltage Vₜₕ of the drive transistor 22, the later described threshold value correcting operation may not be performed. Therefore, the potential relationship expressed as V_{ofs}−Vₛₛ>Vₜₕ is preferably established.

As described above, the operation to fix the gate potential V_{g} of the drive transistor 22 to the reference potential V_{ofs}, and fix (set) the source potential Vₛ to the low potential Vₛₛ is the preparation (the preparation for threshold value correction) to be performed prior to the later described threshold value correcting process (the threshold value correcting operation). Accordingly, the reference potential V_{ofs} and the low potential Vₛₛ are the respective initial potentials of the gate potential V_{g} and the source potential Vₛ of the drive transistor 22.

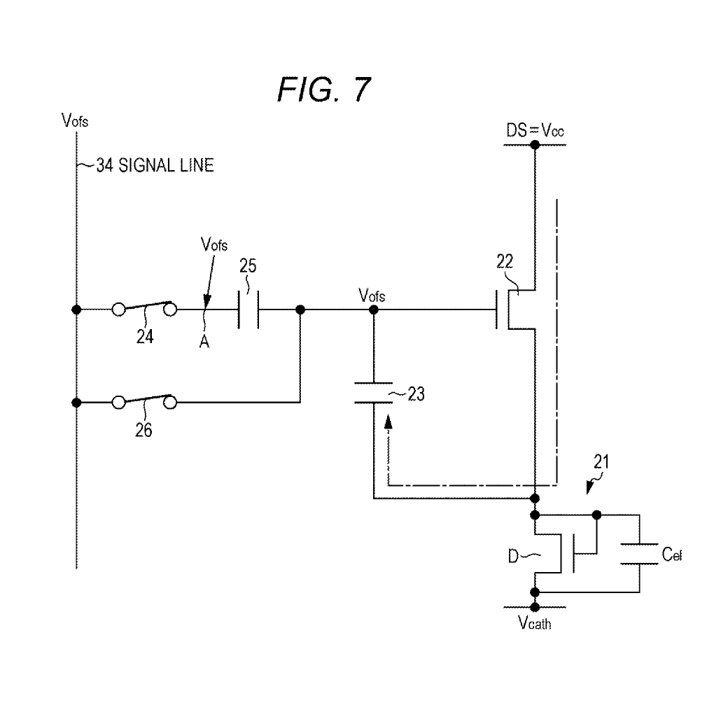

(Threshold Value Correcting Period)

Where the first and second sampling transistors 24 and 26 are in the conductive state, the potential DS of the power supply line 33 switches from the low potential Vₛₛ to the high potential V_{cc} at time t₃. At this point, the current flows through the passage from the power supply line 33 to the drain electrode of the drive transistor 22 to the source electrode to the first capacitative element 23, as indicated by the dot-and-dash arrow in FIG. 7.

Here, the equivalent circuit of the organic EL element 21 is represented by a diode D and a capacitance Cₑₗ, as shown in FIG. 7. Therefore, as long as the voltage Vₑₗ at both ends of the organic EL element 21 is expressed as Vₑₗ is equal to or less than (Vₜₕₑₗ+V_{cath}) (as long as the leakage current from the organic EL element 21 is much smaller than the current flowing in the drive transistor 22), the current flowing in the drive transistor 22 is used to charge the first capacitative element 23 and the equivalent capacitance Cₑₗ of the organic EL element 21.

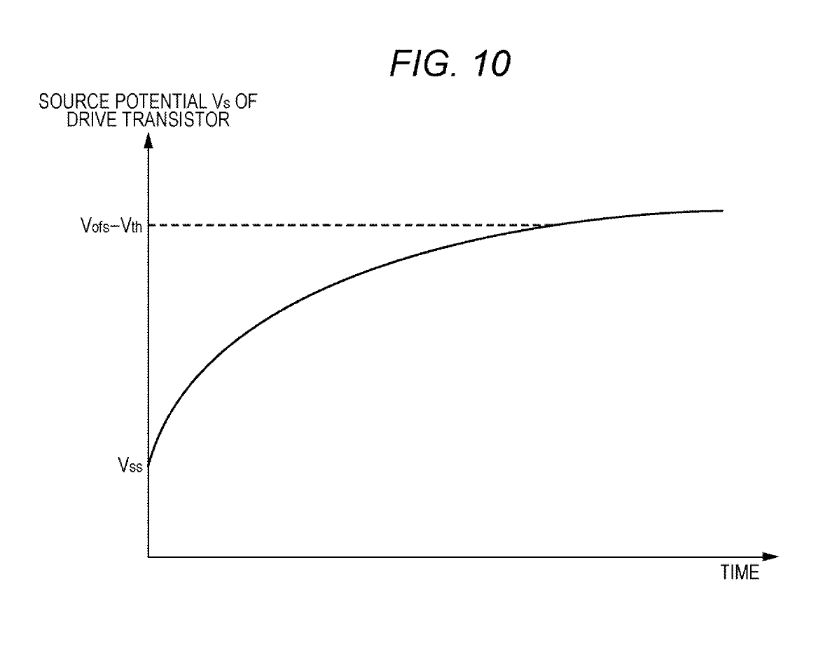

At this point, the voltage Vₑₗ at both ends of the organic EL element 21 becomes higher with the threshold value correcting time, as shown in FIG. 10. After a certain period of time has passed, the gate-source voltage V_{g}, of the drive transistor 22 converges to the threshold voltage Vₜₕ of the drive transistor 22, or becomes equal to the value Vₜₕ. At this point, the relationship, Vₑₗ=V_{ofs}−Vₜₕ (Vₑₗ is equal to or less than (Vₜₕₑₗ+V_{cath})), is preferably established. At time t₄, the potential WS_{B} of the second scanning line 32 transits from the high-potential side to the low-potential side. Accordingly, the second sampling transistor 26 enters a non-conductive state, and the threshold value correcting operation comes to an end.

(Signal Writing & Mobility Correcting Period)

While the first sampling transistor 24 remains in the conductive state, the signal output from the signal output unit 70 to the signal line 34 switches from the reference potential V_{ofs} to the signal voltage V_{sig} of the video signal at time t₅. With that, the signal voltage V_{sig} of the video signal is written into the node A through the first sampling transistor 24. The signal voltage V_{sig} of the video signal is a voltage depending on tone.

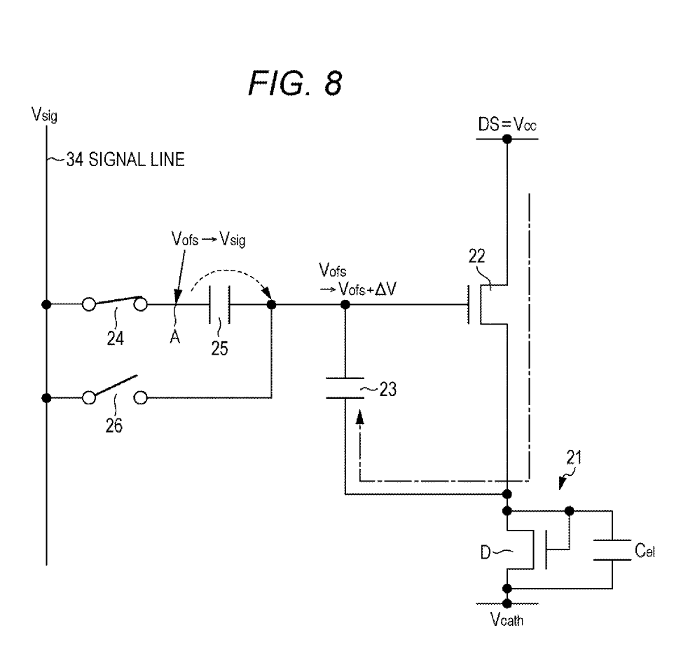

At this point, the variation of the potential V_{A} of the node A is input to the gate electrode of the drive transistor 22 through the second capacitative element 25, as shown in FIG. 8. Here, the gate potential V_{g} of the drive transistor 22 increases from the reference potential V_{ofs} by ΔV, because of the variation of the V_{A} of the node A. Since the current flows into the drive transistor 22 from the power supply line 33, the source potential Vₛ of the drive transistor 22 becomes higher with the lapse of time.

Since the gate electrode of the drive transistor 22 is not electrically connected to the signal line 34 (i.e., since the gate electrode of the drive transistor 22 is floating), the gate potential V_{g} becomes higher as the source potential Vₛ becomes higher. Unless the source potential Vₛ of the drive transistor 22 exceeds the sum of the threshold voltage Vₜₕₑₗ and the cathode voltage V_{cath} of the organic EL element 21 at this point (or if the leakage current from the organic EL element 21 is much smaller than the current flowing in the drive transistor 22), the current flowing in the drive transistor 22 is used to charge the equivalent capacitance Cₑₗ of the organic EL element 21 and the first and second capacitative elements 23 and 25.

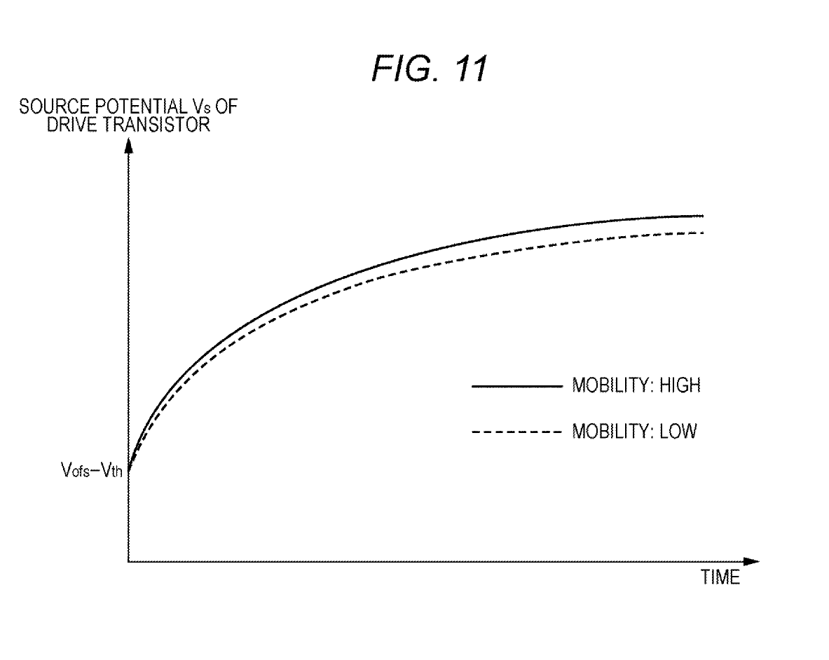

Since the threshold value correcting operation of the drive transistor 22 has been completed at this point, the current flowing in the drive transistor 22 reflects the mobility μ of the drive transistor 22. Specifically, if the mobility μ is high, the amount of current is large, and the source potential Vₛ rapidly becomes higher, as shown in FIG. 11. If the mobility μ is low, on the other hand, the amount of current is small, and the source potential Vₛ slowly becomes higher.

Accordingly, the gate-source voltage V_{g}, of the drive transistor 22 reflects the mobility μ, and has such a value as to complete the correction of the mobility μ after a certain period of time has passed. That is, writing of the signal voltage V_{sig} of the video signal into the pixel 20 and the correction of the mobility μ of the drive transistor 22 are performed in parallel. It should be noted that the mobility μ of the drive transistor 22 is the mobility of the semiconductor thin film forming the channel of the drive transistor 22.

It is assumed herein that the ratio of the hold voltage V_{gs} of the first capacitative element 23 to the signal voltage V_{sig} of the video signal, or the write gain G, is 1 (the ideal value). As a result, the source potential Vₛ of the drive transistor 22 increases to the potential expressed as V_{ofs}−Vₜₕ+ΔVₛ, and accordingly, the gate-source voltage V_{gs} of the drive transistor 22 becomes equal to V_{sig}−V_{ofs}+Vₜₕ−ΔVₛ.

Specifically, the increase ΔVₛ in the source potential Vₛ of the drive transistor 22 is subtracted from the voltage (V_{sig}−V_{ofs}+Vₜₕ) held in the first capacitative element 23, or has an effect to discharge the electric charge stored in the first capacitative element 23. In other words, the increase ΔVₛ in the source potential Vₛ acts as a negative feedback to the first capacitative element 23. Accordingly, the increase ΔVₛ in the source potential Vₛ is the amount of the negative feedback.

As described above, a negative feedback is applied to the gate-source voltage V_{gs} by the amount of the feedback ΔVₛ depending on the drain-source current I_{ds} flowing in the drive transistor 22. In this manner, the dependence of the drain-source current I_{ds} of the drive transistor 22 on the mobility μ can be cancelled. This cancelling process is the mobility correcting process to correct variations in the mobility μ of the drive transistor 22 among the pixels.

More specifically, as the signal amplitude Vᵢₙ (=V_{sig}−V_{ofs}) of the video signal written into the gate electrode of the drive transistor 22 becomes higher, the drain-source current I_{ds} becomes larger, and the absolute value of the amount ΔVₛ of the negative feedback also becomes larger. Therefore, the mobility correcting process in accordance with the emission luminance level is performed.

In a case where the signal amplitude Vᵢₙ of the video signal is constant, the absolute value of the amount ΔVₛ of the negative feedback becomes larger, as the mobility μ of the drive transistor 22 becomes higher. Accordingly, variations in the mobility μ among the pixels can be eliminated. Accordingly, it can be said that the amount ΔVₛ of the negative feedback is the amount of correction in the mobility correcting process.

(Light Emitting Period of the Current Display Frame)

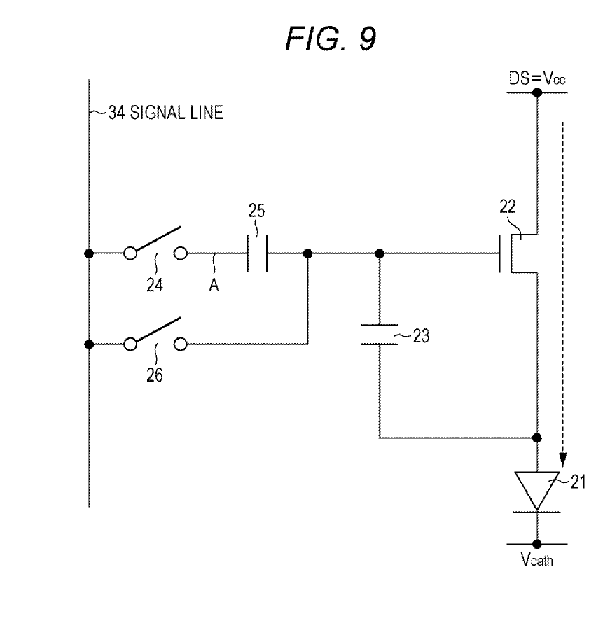

At time t₆, the potential WS_{A} of the first scanning line 31 transits from the high-potential side to the low-potential side, and the first sampling transistor 24 enters a non-conductive state, as shown in FIG. 9. As a result, the signal writing and the mobility correction are completed, and the operation enters a light emitting period of the current display frame.

Since the second sampling transistor 26 is in a non-conductive state, the gate electrode of the drive transistor 22 is electrically cut off from the signal line 34 and thus enters a floating state. When the gate electrode of the drive transistor 22 is in a floating state, the gate potential Vg that varies with a variation of the source potential Vs of the drive transistor 22 also varies, since the first capacitative element 23 is connected between the gate and the source of the drive transistor 22.

Specifically, the source potential Vₛ and the gate potential Vₛ of the drive transistor 22 become higher, while the gate-source voltage V_{qs} held in the first capacitative element 23 is maintained. The source potential Vₛ of the drive transistor 22 increases to the emission voltage V_{oled} of the organic EL element 21 that depends on the saturation current I_{ds} of the transistor.

The operation in which the gate potential V_{g} of the drive transistor 22 varies with the variation of the source potential Vₛ as described above is a bootstrap operation. In other words, a bootstrap operation is an operation in which the gate potential V_{g} and the source potential Vₛ of the drive transistor 22 vary while the gate-source voltage V_{gs} in the first capacitative element 23 or the voltage between both ends of the first capacitative element 23 is maintained.

When the gate electrode of the drive transistor 22 enters a floating state, the drain-source current I_{ds} of the drive transistor 22 starts flowing into the organic EL element 21. As a result, the anode potential of the organic EL element 21 becomes higher in accordance with the current I_{ds}. When the anode potential of the organic EL element 21 exceeds Vₜₕₑₗ+V_{cath}, the drive current starts flowing into the organic EL element 21. Accordingly, the organic EL element 21 starts emitting light.

The emission current of the organic EL element 21 is defined by the saturation current I_{ds} of the drive transistor 22 in accordance with the gate-source voltage V_{gs} at that time. Therefore, the drive transistor 22 serves as a constant current source at each signal voltage V_{sig}.

The increase in the anode potential of the organic EL element 21 is neither more nor less than the increase in the source potential Vₛ of the drive transistor 22. As the source potential Vₛ of the drive transistor 22 becomes higher, the gate potential V_{g} of the drive transistor 22 also becomes higher by virtue of the bootstrap operation of the first capacitative element 23.

If the bootstrap gain is 1 (the ideal value) at this point, the increase in the gate potential V_{g} of the drive transistor 22 becomes equal to the increase in the source potential V. Accordingly, during the light emitting period, the gate-source voltage V_{g}, of the drive transistor 22 is maintained at V_{sig}−V_{ofs}+Vₜₕ−ΔVₛ .

In the above described series of circuit operations, the preparation for threshold value correction, the threshold value correction, the writing of the signal voltage V_{sig} of the video signal (signal writing), and the mobility correction are performed in one horizontal period (1 H). Also, the signal writing and the mobility correction are performed in parallel in the period between time t₅ and time t₆.

{Divided Threshold Value Correction}

Although the drive method by which the threshold value correcting process is performed only once has been described as an example, this drive method is merely an example, and the present disclosure is not limited to the drive method. For example, it is also possible to use a drive method for performing so-called divided threshold value correction by dividing and performing the threshold value correcting process several times over several periods including not only the 1 H period in which the threshold value correcting process is performed together with the mobility correction and the signal writing, but also several horizontal periods prior to the above described 1 H period.

According to the drive method for performing the divided threshold value correction, even if the time allocated as one horizontal period is shortened by an increase in the number of pixels for higher definition, a sufficiently long period of time can be secured over several horizontal periods as the threshold value correcting period. Accordingly, even if the time allocated as one horizontal period is shortened, a sufficiently long period of time can be secured as the threshold value correcting period, and thus, the threshold value correcting process can certainly be performed.

(2-4. Functions and Effects of the Embodiment)

In the organic EL display device 10 in which the pixels 20 each including the organic EL element 21 as a current-drive electrooptic element are arranged in a matrix fashion, the I-V characteristics of an organic EL element 21 deteriorate with time if the light emitting time of the organic EL element 21 becomes longer. As a result, the operating points of the drive transistor 22 and the organic EL element 21 vary. Therefore, even if the same voltage is applied to the gate electrode of the drive transistor 22, the source potential Vₛ of the drive transistor 22 varies. The gate-source voltage V_{gs} of the drive transistor 22 then varies, resulting in a variation of the emission luminance of the organic EL element 21.

In the active-matrix organic EL display device 10 having the above described structure according to this embodiment, on the other hand, the gate-source voltage V_{gs} of the drive transistor 22 is maintained at a constant value by virtue of the bootstrap operation by the first capacitative element 23, and therefore, the current flowing into the organic EL element 21 does not vary. Accordingly, even if the I-V characteristics of the organic EL element 21 deteriorate, the emission luminance of the organic EL element 21 does not vary, as the constant drain-source current I_{ds} continues to flow into the organic EL element 21 (a compensating function against variations in the characteristics of the organic EL element 21).

The organic EL display device 10 according to this embodiment can also adjust the writing time when writing the signal voltage V_{sig} of a video signal by virtue of a function of the timing circuit 27 provided in each pixel 20. Accordingly, even if the time for writing the signal voltage V_{sig} is shortened by blunting of the waveform of the first write scanning signal WS_{A}, the writing time can be adjusted to the original time length that is maintained as long as the waveform is sharp. Thus, the influence of blunting of the waveform of the first write scanning signal WS_{A} on the image quality can be minimized.

As described above, the mobility correcting process to correct variations in the mobility μ of the drive transistor 22 among the pixels is performed in parallel with the writing of the signal voltage V_{sig} during the write period for the signal voltage V_{sig} of a video signal. That is, the time for writing the signal voltage V_{sig} of a video signal is also the mobility correcting time for correcting variations in the mobility μ of the drive transistor 22 among the pixels.

Accordingly, when the waveform of the first write scanning signal WS_{A} becomes blunt due to the influence of a propagation delay caused by the interconnect resistance and the interconnect capacitance of the first scanning line 31 (31₁ through 31ₘ), the mobility correcting time becomes shorter than the optimum correcting time. As a result, an image defect such as shading appears.

Here, the optimum correcting time t for the mobility correction is expressed by the equation: t=C/(kμV_{sig}) (2). In the equation (2), the constant k is expressed as k=(½) (W/L)Cₒₓ. Also, C represents the capacitance of the node discharged at the time of the mobility correction. In the circuit example shown in FIG. 2, C is the combined capacitance of the equivalent capacitance Cₑₗ of the organic EL element 21, the capacitance of the first capacitative element 23, and the capacitance of the second capacitative element 25.

Even when the mobility correcting time becomes shorter than the optimum correcting time t due to blunting of the waveform of the first write scanning signal WS_{A}, the organic EL display device 10 according to this embodiment can prolong the mobility correcting time in the following manner. That is, in the organic EL display device 10 according to this embodiment, the mobility correction is not performed while the gate electrode of the drive transistor is fixed at the potential of the signal line as in the related art disclosed in Patent Document 1, by virtue of a function of the timing circuit 27.

Accordingly, the gate potential V_{g} of the drive transistor 22 also varies with the source potential Vₛ and, in the same period of time, the decrease in the gate-source voltage V_{gs} of the drive transistor 22 is smaller than that in the related art disclosed in Patent Document 1. Thus, the mobility correcting time can be made longer. As a result, measures can be taken against image defects such as shading.

To solve the problem caused by the shortening of the mobility correcting time without using the structure of this embodiment, the buffer size of the peripheral circuit of the pixel array unit 30, or more specifically, the buffer size of the first write scanning unit 40, is preferably made larger. However, a peripheral circuit having an increased buffer size hinders a reduction of the width of the frame of the display panel 80, or hinders miniaturization of the organic EL display device 10.

In the organic EL display device 10 according to this embodiment, on the other hand, influence of blunting of the waveform of the first write scanning signal WS_{A} for driving the first sampling transistor 24 can be made smaller. Accordingly, the frame of the display panel 80 can be made narrower, and the organic EL display device 10 can be made smaller in size.

Also, as described above, higher definition and higher luminance lead to a decrease in the opening area of each pixel, and to a decrease in the overall capacitance. As a result, the time for writing the signal voltage V_{sig} of a video signal tends to become shorter. To counter this problem, the time for writing the signal voltage V_{sig} is adjusted so that the display device can have higher definition and higher luminance.

<3. Modifications>

Although a preferred embodiment has been described so far, the technique according to an embodiment of this disclosure is not limited to the above described embodiment, and various changes and modifications may be made within the scope of this disclosure claimed herein.

For example, in the organic EL display device of the above described embodiment, organic EL elements are used as the electrooptic elements of the pixels 20. However, the technique according to an embodiment of this disclosure is not limited to this application example. Specifically, the technique according to an embodiment of this disclosure can be applied to any display devices using current-drive electrooptic elements (light emitting elements) having emission luminance that varies with the value of current flowing in the device, such as inorganic EL elements, LED elements, and semiconductor laser elements.

Also, in the above described embodiment, when the first sampling transistor 24 is in a conductive state, the operation enters the period of the signal writing and the mobility correction at time t₅, at which the signal voltage V_{sig} of a video signal is supplied to the signal line 34, as is apparent from the timing waveform chart in FIG. 3.

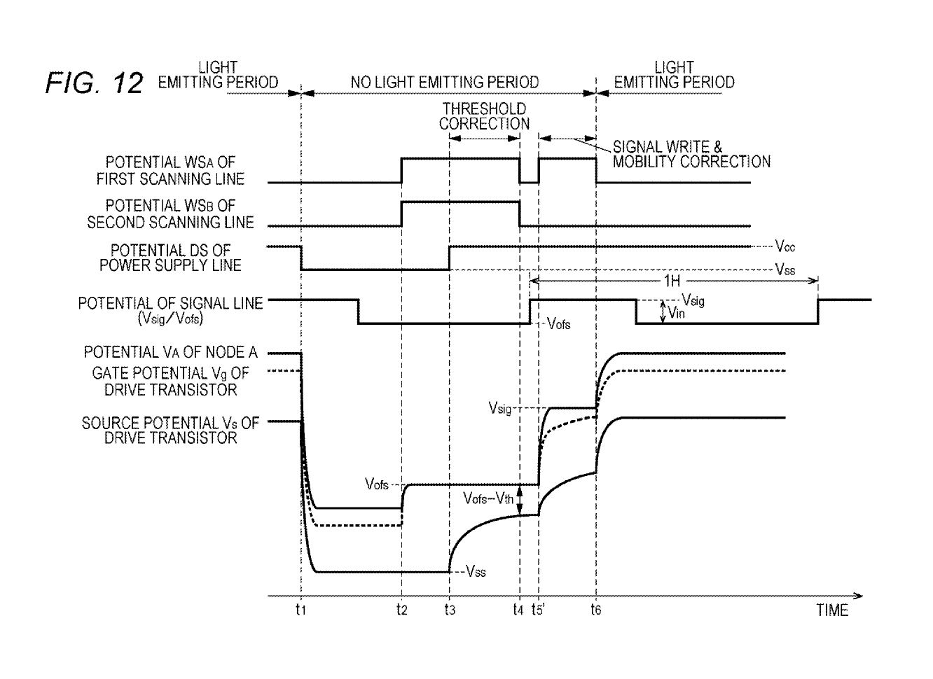

Alternatively, both the first and second sampling transistors 24 and 26 may be put into a non-conductive state when the threshold value correcting operation ends, and the first sampling transistor 24 may be put into a conductive state after the signal voltage V_{sig} of a video signal is supplied to the signal line 34, as shown in the timing waveform chart in FIG. 12. In this case, the operation enters the period of the signal writing and the mobility correction at time t₅′, at which the first sampling transistor 24 is put into a conductive state.

In such a structure, the time for the signal writing and the mobility correction is determined only by the timing for conduction/non-conduction of the first sampling transistor 24. Accordingly, time variations can be advantageously made smaller than in the above described embodiment in which the timing for supplying the signal voltage V_{sig} and the start of the period are determined.

<4. Electronic Apparatus>

The above described display device according to an embodiment of this disclosure can be used as a display unit (a display device) in an electronic apparatus used in various fields in which video signals input to the electronic apparatus or video signals generated in the electronic apparatus are displayed as images or video images.

As is apparent from the above description of the embodiment, the display device according to an embodiment of this disclosure is characteristically capable of reducing image quality degradation caused by blunting of the waveform of the control pulse for a sampling transistor that samples a video signal and writes the video signal into a pixel. Accordingly, high-quality image display can be realized by using the display device according to an embodiment of this disclosure as a display unit in an electronic apparatus used in various fields.

Examples of electronic apparatuses that use the display device according to an embodiment of this disclosure as a display unit include digital cameras, video cameras, game machines, and notebook-size personal computers. Particularly, the display device according to an embodiment of this disclosure is preferably used as a display unit in electronic apparatuses including portable information terminals such as e-book readers and electronic wristwatches, and portable communication devices such as portable telephone devices and PDAs (Personal Digital Assistants).

<5. Structures According to Embodiments of this Disclosure>

This disclosure can be embodied in the following structures.

(1) A display device having a pixel circuit arranged therein, the pixel circuit including an electrooptic element, a drive transistor for driving the electrooptic element, and a first capacitative element connected between the gate electrode of the drive transistor and one of the source/drain electrodes of the drive transistor. In this display device, the pixel circuit writes a video signal, and includes a timing circuit that is capable of adjusting the time for writing the video signal.

(2) The display device of (1), wherein the timing circuit adjusts the time for writing the video signal through capacitance sharing with the first capacitative element.

(3) The display device of (2), wherein the timing circuit is formed with a first sampling transistor having one of its source/drain electrodes connected to a signal line, a second capacitative element connected between the other one of the source/drain electrodes of the first sampling transistor and the gate electrode of the drive transistor, and a second sampling transistor connected between the signal line and the gate electrode of the drive transistor.

(4) The display device of (3), wherein the timing circuit puts the first sampling transistor into a conductive state, and puts the second sampling transistor into a non-conductive state, to write the video signal while applying current to the drive transistor.

(5) The display device of (4), wherein, when writing the video signal, the timing circuit interposes the second capacitative element between the signal line and the gate electrode of the drive transistor, and adjusts the time for writing the video signal through capacitance sharing with the first capacitative element and the second capacitative element.

(6) The display device of (3), wherein, after the video signal is supplied to the signal line, the pixel circuit starts writing the video signal at a time when the first sampling transistor is put into the conductive state.

(7) The display device of any one of (1) to (6), wherein the pixel circuit writes the video signal and corrects the mobility of the drive transistor while applying current to the drive transistor.

(8) The display device of (7), wherein the pixel circuit corrects the mobility of the drive transistor by applying a negative feedback to the potential difference between the gate and the source of the drive transistor by a correction amount that depends on the current flowing in the drive transistor.

(9) A display device having a pixel circuit arranged therein, the pixel circuit including: an electrooptic element; a drive transistor for driving the electrooptic element; a first capacitative element connected between the gate electrode of the drive transistor and one of the source/drain electrodes of the drive transistor; a first sampling transistor having one of its source/drain electrodes connected to a signal line; a second capacitative element connected between the other one of the source/drain electrodes of the first sampling transistor and the gate electrode of the drive transistor; and a second sampling transistor connected between the signal line and the gate electrode of the drive transistor.

(10) An electronic apparatus including a display device having a pixel circuit arranged therein, the pixel circuit including an electrooptic element, a drive transistor for driving the electrooptic element, and a first capacitative element connected between the gate electrode of the drive transistor and one of the source/drain electrodes of the drive transistor. In this electronic apparatus, the pixel circuit writes a video signal, and includes a timing circuit that is capable of adjusting the time for writing the video signal.

(11) A pixel circuit comprising an electro-optical element; a first capacitive element and a second capacitive element, the first capacitive element and the second capacitive element being connected at a node; a first sampling transistor, the second capacitive element being connected to a current terminal of the first sampling transistor, the first sampling transistor being configured to sample an input signal from a signal line connected into at least said second capacitive element; a second sampling transistor; and a drive transistor having a gate terminal, a first current terminal and a second current terminal, the gate terminal being connected to the first capacitive element, the first current terminal being connected to a power supply line, and the second current terminal being connected to the electro-optical element, the drive transistor being configured to apply current to said electro-optical element depending on the input signal held by at least said second capacitive element. During a first period the second sampling transistor is configured to apply a reference potential to the gate terminal of the drive transistor, and during a correction period occurring after of the first period, the second sampling transistor is configured to disconnect the reference potential from the gate terminal of the drive transistor.

(12) The pixel circuit of (11), wherein disconnecting the gate terminal from the reference potential during the correction period causes the gate terminal to float, such that the potential of the gate terminal changes according to a change in the potential of the second current terminal of the drive transistor during the correction period.

(13) The pixel circuit of (12), wherein the first sampling transistor samples the input signal from the signal line during the correction period.

(14) The pixel circuit of (11), wherein the second sampling transistor is connected to the signal line, the signal line being at the reference potential during the first period, and both the first and second sampling transistors are configured to be turned on during the first period, such that the node connecting the first capacitive element and the second capacitive element is caused to be at the reference potential during the first period, the node being connected to the gate terminal of the drive transistor.

(15) The pixel circuit of (14), wherein the signal line is at the input signal potential during the correction period, the first sampling transistor configured to be turned on during the correction period, the second sampling transistor configured to be turned off during the correction period, such that the first sampling transistor samples the input signal into at least the second capacitive element during the correction period, while the second sampling transistor floats the gate terminal of the drive transistor.

(16) The pixel circuit of (11), wherein the first capacitive element is connected to the electro-optical element and the gate terminal of the drive transistor, and the second capacitive element has a first terminal connected to the current terminal of the sampling transistor and a second terminal connected to the gate terminal of the drive transistor.

(17) The pixel circuit of (16), wherein the second sampling transistor is connected to the signal line, the signal line being at the reference potential during the first period, and both the first and second sampling transistors are configured to be turned on during the first period, such that the reference potential is applied to the first and second terminals of the second capacitive element during the first period.

(18) The pixel circuit of 17, wherein the signal line is at the input signal potential during the correction period, the first sampling transistor configured to be turned on during the correction period, and the second sampling transistor configured to be turned off during the correction period, such that the first sampling transistor samples the input signal into at least the second capacitive element during the correction period, while the second sampling transistor floats the gate terminal of the drive transistor.

(19) The pixel circuit of (18), wherein a negative feedback current flows from the second current terminal of the drive transistor to the second capacitive element during the correction period.

(20) The pixel circuit of (11), wherein a negative feedback current flows from the second current terminal of the drive transistor to the second capacitive element during the correction period to provide a mobility correction for the drive transistor.

(21) A display device comprising a plurality of pixel circuits according to (11); and at least one scanning unit configured to provide the reference potential and the input signal potential on the signal line and to provide control signals to the first and second sampling transistors.

(22) An electronic apparatus comprising the display device according to (21).

(23) The electronic apparatus of (22), wherein disconnecting the gate terminal from the reference potential during the correction period causes the gate terminal to float, such that the potential of the gate terminal changes according to a change in the potential of the second current terminal of the drive transistor during the correction period.

(24) The electronic apparatus of (23), wherein the first sampling transistor samples the input signal from the signal line during the correction period.

(25) The electronic apparatus of (22), wherein the second sampling transistor is connected to the signal line, the signal line being at the reference potential during the first period, and both the first and second sampling transistors are configured to be turned on during the first period, such that the node connecting the first capacitive element and the second capacitive element is caused to be at the reference potential during the first period, the node being connected to the gate terminal of the drive transistor.

(26) The electronic apparatus of (25), wherein the signal line is at the input signal potential during the correction period, the first sampling transistor configured to be turned on during the correction period, the second sampling transistor configured to be turned off during the correction period, such that the first sampling transistor samples the input signal into at least the second capacitive element during the correction period, while the second sampling transistor floats the gate terminal of the drive transistor.

(27) The electronic apparatus of (22), wherein the first capacitive element is connected to the electro-optical element and the gate terminal of the drive transistor, and the second capacitive element has a first terminal connected to the current terminal of the sampling transistor and a second terminal connected to the gate terminal of the drive transistor.

(28) The electronic apparatus of (27), wherein the second sampling transistor is connected to the signal line, the signal line being at the reference potential during the first period, and both the first and second sampling transistors are configured to be turned on during the first period, such that the reference potential is applied to the first and second terminals of the second capacitive element during the first period.

(29) The electronic apparatus of (28), wherein the signal line is at the input signal potential during the correction period, the first sampling transistor configured to be turned on during the correction period, and the second sampling transistor configured to be turned off during the correction period, such that the first sampling transistor samples the input signal into at least the second capacitive element during the correction period, while the second sampling transistor floats the gate terminal of the drive transistor.

(30) The electronic apparatus of (29), wherein a negative feedback current flows from the second current terminal of the drive transistor to the second capacitive element during the correction period.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2012-191639 filed in the Japan Patent Office on Aug. 31, 2012, the entire content of which is hereby incorporated by reference.

### REFERENCE SIGNS LIST

10 Organic EL display device

20 Pixel (pixel circuit)

21 Organic EL element

22 Drive transistor

23 First capacitative element

24 First sampling transistor

25 Second capacitative element

26 Second sampling transistor

27 Timing circuit

30 Pixel array unit

31 (31₁-31ₘ)First scanning line

32 (32₁-32ₘ)Second scanning line

33 (33₁-33ₘ)Power supply line

34 (34₁-34ₙ) Signal line

35 Common power supply line

40 First write scanning unit

50 Second write scanning unit

60 Power supply scanning unit

70 Signal output unit

80 Display panel

1. A pixel circuit comprising:
an electro-optical element;
a first capacitive element and a second capacitive element, the first capacitive element and the second capacitive element being connected at a node;
a first sampling transistor, the second capacitive element being connected to a current terminal of the first sampling transistor, the first sampling transistor being configured to sample an input signal from a signal line connected into at least said second capacitive element;
a second sampling transistor; and
a drive transistor having a gate terminal, a first current terminal and a second current terminal, the gate terminal being connected to the first capacitive element, the first current terminal being connected to a power supply line, and the second current terminal being connected to the electro-optical element, the drive transistor being configured to apply current to said electro-optical element depending on the input signal held by at least said second capacitive element, wherein during a first period the second sampling transistor is configured to apply a reference potential to the gate terminal of the drive transistor, and during a correction period occurring after of the first period, the second sampling transistor is configured to disconnect the reference potential from the gate terminal of the drive transistor.

2. The pixel circuit according to claim 1, wherein disconnecting the gate terminal from the reference potential during the correction period causes the gate terminal to float, such that the potential of the gate terminal changes according to a change in the potential of the second current terminal of the drive transistor during the correction period.

3. The pixel circuit according to claim 2, wherein the first sampling transistor samples the input signal from the signal line during the correction period.

4. The pixel circuit according to claim 1, wherein the second sampling transistor is connected to the signal line, the signal line being at the reference potential during the first period, and both the first and second sampling transistors are configured to be turned on during the first period, such that the node connecting the first capacitive element and the second capacitive element is caused to be at the reference potential during the first period, the node being connected to the gate terminal of the drive transistor.

5. The pixel circuit according to claim 4, wherein the signal line is at the input signal potential during the correction period, the first sampling transistor configured to be turned on during the correction period, the second sampling transistor configured to be turned off during the correction period, such that the first sampling transistor samples the input signal into at least the second capacitive element during the correction period, while the second sampling transistor floats the gate terminal of the drive transistor.

6. The pixel circuit according to claim 1, wherein the first capacitive element is connected to the electro-optical element and the gate terminal of the drive transistor, and the second capacitive element has a first terminal connected to the current terminal of the sampling transistor and a second terminal connected to the gate terminal of the drive transistor.

7. The pixel circuit according to claim 6, wherein the second sampling transistor is connected to the signal line, the signal line being at the reference potential during the first period, and both the first and second sampling transistors are configured to be turned on during the first period, such that the reference potential is applied to the first and second terminals of the second capacitive element during the first period.

8. The pixel circuit according to claim 7, wherein the signal line is at the input signal potential during the correction period, the first sampling transistor configured to be turned on during the correction period, and the second sampling transistor configured to be turned off during the correction period, such that the first sampling transistor samples the input signal into at least the second capacitive element during the correction period, while the second sampling transistor floats the gate terminal of the drive transistor.

9. The pixel circuit according to claim 8, wherein a negative feedback current flows from the second current terminal of the drive transistor to the second capacitive element during the correction period.

10. The pixel circuit according to claim 1, wherein a negative feedback current flows from the second current terminal of the drive transistor to the second capacitive element during the correction period to provide a mobility correction for the drive transistor.

11. A display device comprising:
a plurality of pixel circuits according to claim 1; and
at least one scanning unit configured to provide the reference potential and the input signal potential on the signal line and to provide control signals to the first and second sampling transistors.

12. An electronic apparatus comprising the display device according to claim 11.

13. The electronic apparatus according to claim 12, wherein disconnecting the gate terminal from the reference potential during the correction period causes the gate terminal to float, such that the potential of the gate terminal changes according to a change in the potential of the second current terminal of the drive transistor during the correction period.

14. The electronic apparatus according to claim 13, wherein the first sampling transistor samples the input signal from the signal line during the correction period.

15. The electronic apparatus according to claim 12, wherein the second sampling transistor is connected to the signal line, the signal line being at the reference potential during the first period, and both the first and second sampling transistors are configured to be turned on during the first period, such that the node connecting the first capacitive element and the second capacitive element is caused to be at the reference potential during the first period, the node being connected to the gate terminal of the drive transistor.

16. The electronic apparatus according to claim 15, wherein the signal line is at the input signal potential during the correction period, the first sampling transistor configured to be turned on during the correction period, the second sampling transistor configured to be turned off during the correction period, such that the first sampling transistor samples the input signal into at least the second capacitive element during the correction period, while the second sampling transistor floats the gate terminal of the drive transistor.

17. The electronic apparatus according to claim 12, wherein the first capacitive element is connected to the electro-optical element and the gate terminal of the drive transistor, and the second capacitive element has a first terminal connected to the current terminal of the sampling transistor and a second terminal connected to the gate terminal of the drive transistor.

18. The electronic apparatus according to claim 17, wherein the second sampling transistor is connected to the signal line, the signal line being at the reference potential during the first period, and both the first and second sampling transistors are configured to be turned on during the first period, such that the reference potential is applied to the first and second terminals of the second capacitive element during the first period.

19. The electronic apparatus according to claim 18, wherein the signal line is at the input signal potential during the correction period, the first sampling transistor configured to be turned on during the correction period, and the second sampling transistor configured to be turned off during the correction period, such that the first sampling transistor samples the input signal into at least the second capacitive element during the correction period, while the second sampling transistor floats the gate terminal of the drive transistor.

20. The electronic apparatus according to claim 19, wherein a negative feedback current flows from the second current terminal of the drive transistor to the second capacitive element during the correction period.
